(19) United States
(12) Patent Application Publication
(10) Pub. No.: US 2015/0261389 A1
(43) Pub. Date: Sep. 17, 2015

(54) Communication Event History

(71) Applicant: Microsoft Corporation, Redmond, WA (US)

(72) Inventor: Umberto Abate, London (GB)

(21) Appl. No.: 14/448,908

(22) Filed: Jul. 31, 2014

(30) Foreign Application Priority Data
Mar. 14, 2014 (GB) 1404612.2

(51) Int. Cl. G06F 3/0481; H04N 7/14; H04L 29/08

(52) U.S. Cl. CPC G06F 3/0481; H04L 67/06; H04L 67/10; H04N 7/147

(57) ABSTRACT

In the following, communication event data are transmitted and received between a user device and a communication network. The communication event data is of a plurality of communication events conducted over an interval of time. Transmitted and/or received communication event data of the communication events is selectively marked as highlighted communication event data. The communication events are grouped into different groups. Each of said groups is represented by displaying, in a respective portion of an available display area of the display, the highlighted communication event data of a communication event in that group. Responsive to a user selecting that portion of the available display area, an access component is configured to access a record of at least one communication event in that group.

### RELATED APPLICATIONS

This application claims priority under 35 USC §119 or §365 to Great Britain Patent Application No. 1404612.2 entitled “COMMUNICATION EVENT HISTORY” filed Mar. 14, 2014, the disclosure of which is incorporate in its entirety.

### BACKGROUND

Conventional communication systems allow a user of a device, such as a personal computer or mobile device, to conduct voice or video calls over a packet-based communication network such as the Internet. Such communication systems include voice or video over internet protocol (VoIP) systems. These systems are beneficial to the user as they are often of significantly lower cost than conventional fixed line or mobile cellular networks. This may particularly be the case for long-distance communication. To use a VoIP system, the user installs and executes client software on their device. The client software may be distributed by an operator of the communication system. The client software sets up the VoIP connections as well as providing other functions such as registration and authentication. Remote voice/video data of a call is received from a remote user and local voice/video data is captured and the user device and transmitted to the remote user as part of the call. The play-out and transmission of the call data occurs in real-time such that the user and the remote user are able to maintain an interactive conversation with one another.

In addition to voice and video communication, the client may also set up connections for other communication media such as instant messaging (“IM”), SMS messaging, file transfer and voicemail. That is, the client may be operable to transmit communication event data of different types of communication events (such as audio/video calls, instant messaging sessions, file transfers etc.) between the user device and the communication network. Calls and other communication events may be conducted between two or more users and involve two or more user devices.

The communication client may maintain a history of past communication events by storing respective records of some or all of the past communications in local computer storage of the user device. The record may comprise some or all of the transmitted and received communication event data itself—for instance, previously transmitted instant messages, SMS messages, previously transmitted and received files etc . . . The record may also comprise additional information about the various past communication events—for instance the duration, time and date of past audio/video calls, the time and date of missed audio/video calls, transmit/receipt time of transmitted/received IMs, SMS messages and files etc. The records may, for example, be retained for an interval of up to six months then deleted.

The client may display the various communication event records to the user in the form of a linear conversation history. For instance, the client may display all historic communication events between the user of the device and another selected user in sequence (that is, in the temporal order in which they occurred). This may include different types of communication events such that, for instance, records of historic audio calls, video calls, instant messages, file transfers etc. are all shown as part of the same conversation history. For instance, all instant messages between the user and the selected user over the past six months may be displayed in conjunction with the respective times and dates at which they were transmitted or received and the displayed messages may be interspersed with displayed records of other communication events, such as audio/video calls and file transfers, disposed in the displayed sequence of messages at appropriate positions to reflect when those communication events occurred relative to transmission or receipt of the displayed instant messages.

### SUMMARY

The disclosure provides a computer system in which communication event data are transmitted and received between a user device and a communication network. The communication event data is of a plurality of communication events conducted over an interval of time. The computer system comprises computer storage, a highlight component, a grouping component and an access component. The computer storage is operable to store respective records of the communication events. Each record of a communication event includes one or more parameters of that communication event. The highlight component is operable to selectively mark transmitted and/or received communication event data of the communication events as highlighted communication event data. The grouping component is configured to access the records to group the communication events into a plurality of groups by matching the respective parameters of the communication events. The access component is configured to generate control signals to control a display of the user device to represent each of said groups by displaying, in a respective portion of an available display area of the display, the highlighted communication event data of a communication event in that group. Responsive to a user selecting that portion of the available display area, the access component is configured to access the record of at least one communication event in that group.

Also disclosed are a corresponding computer implemented method and computer program product comprising executable program code configured to implement that method when executed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF DRAWINGS

For a better understanding of the present subject matter and to show how the same may be carried into effect, reference will now be made by way of example to the accompanying drawings in which:

FIG. 1 is a schematic illustration of a communication system;

FIG. 2 is a schematic block diagram of a user device;

FIG. 3 is a schematic block diagram representing functionality of a user device executing a client application;

FIG. 4 is a schematic flow chart for a communication event management method;

FIG. 5A is a schematic illustration of a client user interface operating in a group-by-highlight mode;

FIG. 5B is a schematic illustration of a client user interface operating in a group-by-topic mode;

FIG. 5C is a schematic illustration of a client user interface operating in a group-by-media-type mode;

FIG. 5D is a schematic illustration of a client user interface operating in a group-by-place mode;

FIG. 6 is a schematic illustration of a client user interface operating in a conversation mode;

FIG. 7 is a schematic illustration of a client user interface during a video call;

FIG. 8 is a schematic illustration of a client user interface operating in a video-playback mode;

FIG. 9 is a schematic illustration of a client user interface operation in an image-view mode.

### DETAILED DESCRIPTION

Embodiments will now be described by way of example only.

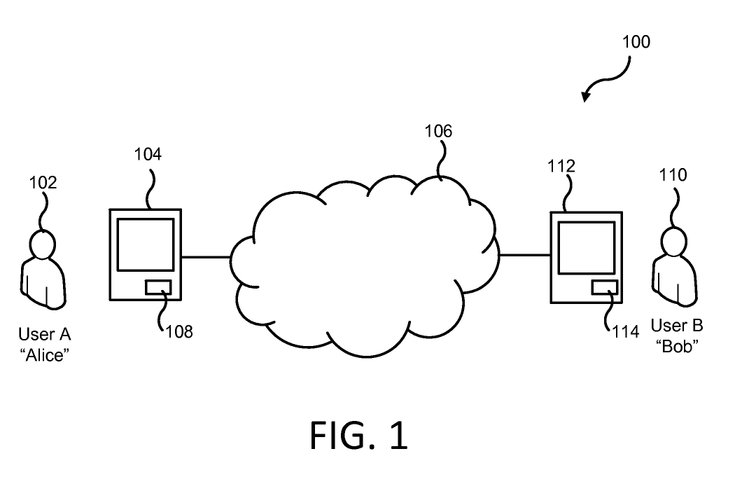

Reference is first made to FIG. 1, which illustrates a packet-based communication system 100. A first user 102 of the communication system (User A or “Alice” 102) operates a user device 104, which is shown connected to a communications network 106. The communications network 106 may for example be the Internet. The user device 104 may be, for example, a mobile phone (e.g. smartphone), a personal digital assistant (“PDA”), a personal computer (“PC”) (including, for example, Windows™, Mac OS™ and Linux™ PCs), a gaming device, tablet computing device or other embedded device able to connect to the network 106. The user device 104 is arranged to receive information from and output information to the user 102 of the device. The user device 104 comprises a display such as a screen and an input device such as a keypad, joystick, touchscreen, keyboard, mouse, microphone and/or webcam.

Note that in alternative embodiments, the user device 104 can connect to the communication network 106 via additional intermediate networks not shown in FIG. 1. For example, if the user device 104 is a mobile device, then it can connect to the communication network 106 via a cellular mobile network (not shown in FIG. 1), for example a GSM or UMTS network.

The user device 104 is running a communication client 108, provided by the software provider associated with the communication system 100. The communication client 108 is a software program executed on a local processor in the user device 104 which allows the user device 104 to establish communication events—such as audio calls, video calls, instant messaging communication sessions, and inter-client file transfers including media file transfers (e.g. audio and/or video and/or static image files) and/or other data (such as other types of file)—over the network 106.

FIG. 1 also shows a second user 110 (User B or “Bob”) who has a user device 112 which executes a client 114 in order to communicate over the network 106 in the same way that the user device 104 executes the client 108 to communicate over the network 106. Therefore users A and B (102 and 110) can communicate with each other over the communications network 106. There may be more users connected to the communications network 106, but for clarity only the two users 102 and 110 are shown connected to the network 106 in FIG. 1.

Communication events between Alice and Bob can be established using the clients 108, 112 in various ways. For instance, a call can be established by one of Alice and Bob instigating a call invitation to the other (either directly or indirectly by way of an intermediary network entity such as a server or controller) which the other accepts, and can be terminated by one of Alice and Bob electing to end the call at their client. An instant messaging communication session is established by one of Alice and Bob instigating an initial instant message to the other and may be terminated e.g. upon Alice or Bob logging off and/or after a predetermined period of inactivity. A file transfer can be established, for instance, by one of Alice and Bob instigating a file transfer request to the other and the other choosing to accept the file transfer at their client, at which point transmission of the file begins. The file transfer may be terminated either upon completion of the file transfer, or during the file transfer if the recipient (or sender) decides that they no longer which to accept (or send) that file.

Each communication client instance 104, 112 has a log in/authentication facility which associates the user devices 104, 112 with their respective users 102, 110 e.g. by the user entering a username and password at the client and which is verified against user account data stored at a server (or similar) of the communication system 100 to as part of an authentication procedure. Users can have communication client instances running on other devices associated with the same log in/registration details.

In the case where the same user, having a particular username, can be simultaneously logged in to multiple instances of the same client application on different devices, a server (or similar) is arranged to map the username (user ID) to all of those multiple instances but also to map a separate sub-identifier (sub-ID) to each particular individual instance. Thus the communication system is capable of distinguishing between the different instances whilst still maintaining a consistent identity for the user within the communication system.

User 102 is logged-in (authenticated) at client 108 of device 104 as “User A”. User 112 is logged-in (authenticated) at client 114 of device 114 as “User B”.

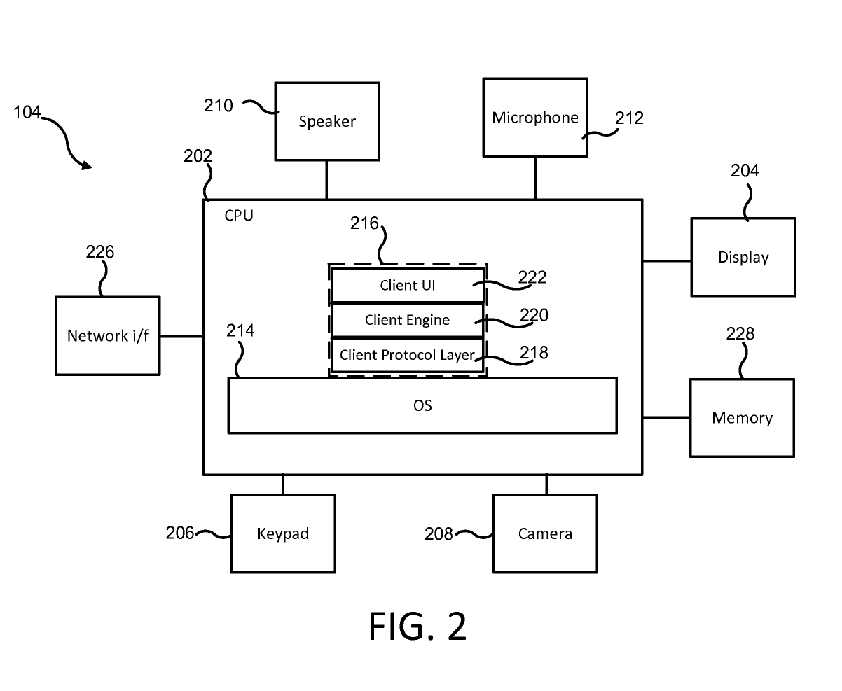

FIG. 2 illustrates a detailed view of the user device 104 on which is executed client 108. The user device 104 comprises a central processing unit (“CPU”) 202, to which is connected an output device in the form of a display 204 such as a screen (having an available display area), input devices such as a keypad (or a keyboard) 206 and a camera 208 for capturing video data. The display 204 comprises a touchscreen (input device) for inputting data to the CPU 202, but may alternatively or additionally comprise other input devices such as a computer mouse and/or track pad. An output audio device 210 (e.g. a speaker) and an input audio device 212 (e.g. a microphone) are connected to the CPU 202. The display 204, keypad 206, camera 208, output audio device 210 and input audio device 212 are integrated into the user device 104. In alternative user devices one or more of the display 204, the keypad 206, the camera 208, the output audio device 210 and the input audio device 212 may not be integrated into the user device 104 and may be connected to the CPU 202 via respective interfaces. One example of such an interface is a USB interface. The CPU 202 is connected to a network interface 226 such as a modem for communication with the communications network 106 for communicating over the communication system 100. The network interface 226 may be integrated into the user device 104 as shown in FIG. 2. In alternative user devices the network interface 226 is not integrated into the user device 104. FIG. 2 shows one CPU but alternative user devices may comprise more than one CPU e.g. which constitute cores of a multi-core processor.

FIG. 2 also illustrates an operating system (“OS”) 214 executed on the CPU 202. Running on top of the OS 214 is a software stack 216 for the client 108. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the network via the network interface 226. The client protocol layer 218 of the client software communicates with the operating system 214 and manages the connections over the communication system 100. Processes requiring higher level processing are passed to the client engine layer 220. The client engine 220 also communicates with the client user interface layer 222. The client engine 220 may be arranged to control the client user interface layer 222 to present information to the user via a user interface of the client and to receive information from the user via the user interface. This includes displaying information in the available area of the display (i.e. the area of the display available to the client 108 which may or may not be the entirety of the display).

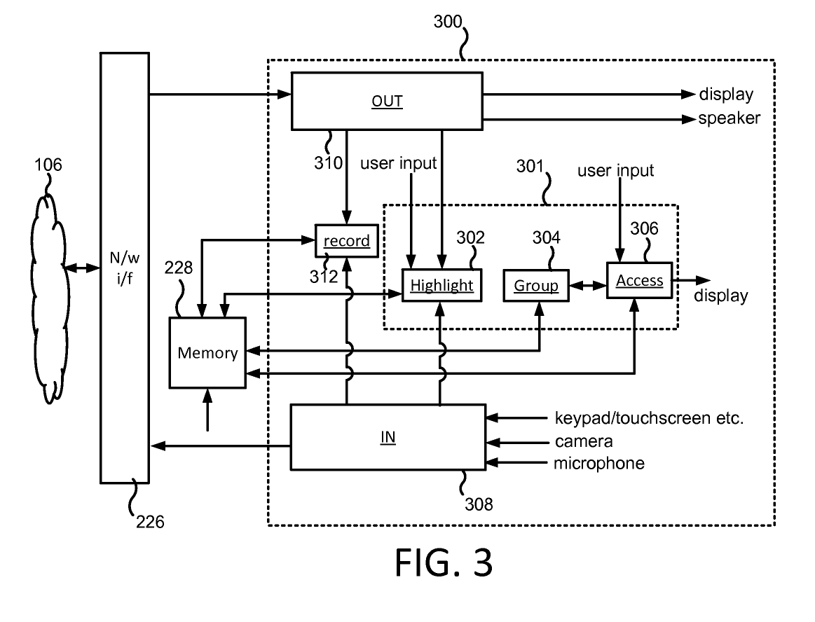

With reference to FIGS. 3 to 9, there will now be described a communication event grouping method. FIG. 3 is a block diagram of a part of the user device 104 in which blocks represent respective functionality implemented by the user device. FIG. 3 shows a communication event data processing system 300 which represents the communication event data processing functionality implemented by executing the client 108 on the CPU 202 of the user device 104. The system 300 comprises various functional blocks (components) each of which represents respective functionality implemented by executing the client 108 at the user device 104.

As shown in FIG. 3 the user device 104 comprises the network interface 226, the memory 228, and the system 300. The system 300 comprises a record component 312, an output component 310 configured to receive communication event data from the communication network 106 which it processes and supplies to a suitable output device of the user device such as the display 204 (for display thereon) or speaker 210 (for playing out therefrom). For instance, the communication event data may comprise instant message data which is processed and displayed as text; audio call (resp. video call) communication event data which is processed and played-out via the speaker 201 (resp. displayed as moving images on the display 204) in real-time; and media (and/or other) file data which processed to extract media (and/or other) file(s) therefrom for storage in memory 228 and which the client 108 can then play out via the display 204 and/or the speaker 210 (or open in another application) as appropriate for as long as the files remain in memory 228.

The system 300 further comprises an input component 308 configured to receive data from input devices of the user device 104 such as the microphone 212, the camera 208, the keypad 206 and/or touchscreen. The input component processes the received input data supplies the processed data to the network interface 228 for transmission over the communication network 106 to Bob 110.

The record component 312 is operable to record communication events conducted using the client 108 by creating records of those communication events in memory 228, and updating those records as appropriate. Both the input component 308 and the output component 310 can interact with the record component 312 to this end to enable the record component 312 to keep track of transmission and receipt of communication event data between the user device 102 and the network 106. This is illustrated in FIG. 3 by the respective arrows connecting the input and output components to the record component 312, and is discussed in further detail below.

Respective records of past communication events are thus stored in the memory 228. Each record of a communication event includes data about that communication event (record metadata) although the constitution of each communication event record depends, to some extent, on the type of that communication event (types being e.g. a voice call, a video call, an instant messaging communication session, a media or other transfer etc.). The record of a communication event includes one or more timestamps recording time(s) and/or dates(s) which are relevant to that communication event. For instance, the record of a voice or video call could include a timestamp recording a time at which that call was established; the record of an instant messaging communication session could include a respective timestamp for each instant message transmitted and received in the session, each timestamp recording a time of message transmission or receipt as appropriate; the record of a file transfer could include a timestamp recording a time at which the file transfer was instigated and/or successfully completed, if so completed. Additional information about a communication event may also be stored as part of its record. For instance, in embodiments, the record of a voice or video call also records the duration of the call and identifiers of one or more other users who participated in the call; the record of an instant messaging session also includes identifiers of one or more other users who participated in the session and information about each message transmitted or received in the session; the record of a file transfer also includes an identifier of a user by which that file transfer was instigated, a name of that file, and an indication of where in memory 228 that file is stored.

The time stamp of a communication event is an example of a parameter of that communication event. The record of a communication event may also comprise other parameters (record metadata) of that communication event, such as: respective locations of one or more participants of that communication event (e.g. Alice's location and/or Bob's location respectively determined at Alice's device based on a GPS signal and received from Bob's device over the network 106); a media type of that communication event i.e. whether the communication event is an audio call, a video call, an IM session, an image transfer, or a file transfer etc.; and/or a topic of that communication event assigned e.g. by identifying predetermined keywords relating to that topic by applying a text recognition procedure to IMs and/or a speech recognition procedure to call audio. The parameter of a communication event is assigned to that communication event by the client 108, either during the communication event or following termination of the communication event based on information in the record of that communication event. For instance, a topic may be assigned to a call based on performing the aforementioned speech recognition procedure during the call, whereas a topic could be assigned to an instant messaging session by the client 108 performing the aforementioned text recognition procedure to IMs of that session stored in the relevant communication event records.

In addition to metadata, the record of a communication event can comprise some or all of the transmitted and received communication event data of that communication event itself (record data)—for instance, for instant messaging sessions and file transfers, the record comprises previously transmitted instant messages and previously transmitted and received files respectively. Further, as discussed in more detail below, the record of an audio or video call can comprise selectively highlighted communication event data of that communication event, such as audio, video or still image extracts captured during the call and stored in the record in conjunction with the call metadata.

Each of the stored records constitutes a conversation element of a conversation history. The collection of conversation elements constitutes the conversation history, the conversation history being an aggregate record of historic interactions between Alice and Bob (and possibly between Alice and other users) over a period of e.g. weeks, months or years.

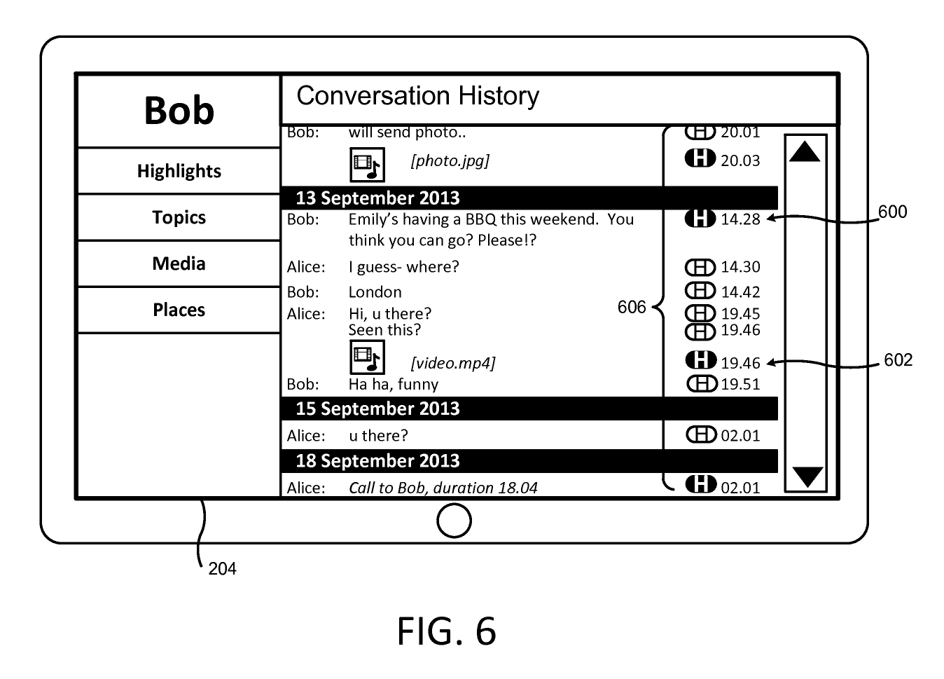

The client user interface of the client 108 can operate in a number of different modes in order to represent (parts of) the conversation history to the user 102 as desired in an available area of the display 204 (that is in an area of the display available to the client 108). One such mode of operation is a conversation mode in which at least a portion of the conversation history corresponding to a particular interval of time is displayed in sequence; that is, conversation elements for communication events in that period of time are displayed in the temporal order in the corresponding communication events occurred. This is illustrated in FIG. 6 which shows an exemplary view of the display 204 of the user device 104 when the client user interface is operating in the conversation mode. The user 102 can scroll through the displayed conversation history to view conversation elements at different points in time. In this example, instant messages that have been transmitted and received between Alice and Bob are displayed in conjunction with their corresponding timestamps and the identity of the instigating user. Information about calls and file transfers is also displayed in conjunction with the corresponding timestamps. Each historic call is represented by a displayed textual descriptor which includes an indication of the duration of that call. Each historic file transfer is represented by displaying an icon and a file name of the file.

The system 300 also comprises a record maintenance and access system 301 for organizing the communication event records stored in memory 228 and for granting access to the organized communication event records to the user 102 in an intuitive manner. To this end, the record maintenance and access system comprises a highlight component 302, a grouping component 304 and an access component 306. The highlight component 302 has first and second inputs respectively configured to receive data from the output component 210 and from the input component 308. The highlight component 302 is able to access the memory 228 both to store and retrieve data and is responsive to user inputs at the user device 104. The group component 304 is able to access the memory 228 both to store and retrieve data. The access component 306 is able to access the memory 228 both to store and retrieve data and is also responsive to user inputs at the user device 104. The access component is also able to control the display to present information to the user 102.

Among other things, the highlight component is operable to selectively mark transmitted and received communication event data of the communication events as highlighted communication event data. The grouping component is configured to access the records to group the communication events into a plurality of groups by matching the parameters of the communication events, and to also modify the records (e.g. to augment the records with further information derived automatically from processing of transmitted/received communication event data or input manually by the user 102) for use in that grouping of communication events. The access component is provides access to the records to the user 102 in a manner which is efficient and intuitive. This is described in more detail below.

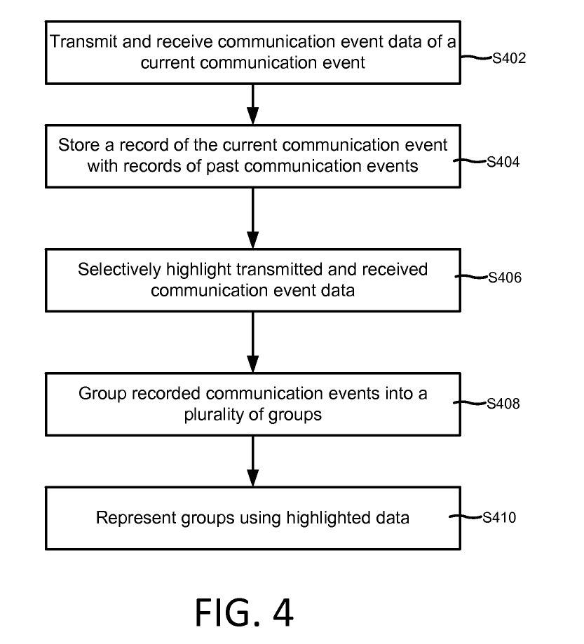

The method will now be described with reference to FIG. 4 which is a flow chart for the method.

At step S402 the client 108 transmits and receives communication event data of a current communication event. In this embodiment, the communication event is conducted between Alice 102 and Bob 110 and communication event data of the current communication event is variously transmitted to, and received from, the user device 108. In other embodiments, communication event data of a communication event may be transmitted and received between more than two users and more than two user devices. The communication event may be established by Alice sending an initial message (such as an instant message, call invitation, or file transfer request) to Bob, or vice versa, via the communication network 106. The communication event communication data can comprise, for instance, real-time media (e.g. audio and video) data of a voice or video call to be played out at Alice's user device 104 or Bob's user device 112 as part of a call, text data of one or more instant messages to be displayed at Alice's user device 104 or Bob's user device 112 as part of an instant messaging communication session, or file data of a file transfer—such as non-real-time media data of one or more media files (e.g. audio file(s), video file(s), and/or static image file(s)) and/or file data of other types of file.

At step S404 the record component 312 records the communication event by creating a record of the current communication event in the memory 228 which is stored with the various records of past communication events previously created by the record component 312. As discussed, the record of a communication event comprises record metadata of that communication event and possibly also some or all of the transmitted and received communication event data of that communication event itself (which constitutes record data of the record). As will be appreciated, the record component can record the communication event in numerous different ways. For instance, in one embodiment, the client creates a database entry in a database stored in memory 228 for a communication event in response to Alice selecting an option to send a communication event invitation to Bob or upon receipt of such an invitation from Bob (to Alice). The client then updates the database in response to salient actions—such as successful establishment of the communication event, failure to establish the communication event, transmission or receipt of a message of the communication event if applicable (e.g. transmission or receipt of an instant message), termination of the communication event etc. This can include, for instance, recording times relating to some or all of those salient actions—such as an establishment time of a call and a duration of the established call. For instant messaging communication events, the record component saves transmitted and received instant messages in the database and the time at which each message was sent or received. For file transfer communication events, the record component 312 also stores an indication of which files have been transmitted (by Alice to Bob) and received (from Bob by Alice) in the database and where those files have been stored in memory 228 by the client 108.

At step S406, the highlight component 302 of the client 108 selectively highlights transmitted and received communication event data by selectively marking transmitted and received communication event data of the communication event as highlighted communication event data. Here, “highlighted communication event data” is used to mean communication data which is considered to be of particular interest to Alice 102 and which represents a highlighted moment of interaction between Alice and Bob 102, 112 e.g. a moment that is likely to be of particular interest to Alice, to which Alice is likely to return to in her conversation history.

In this embodiment, a piece of communication event data is marked as highlighted by the highlight component 302 applying additional metadata indicating a highlighted moment to the record of that communication event—that is, by augmenting a record of a communication event with metadata identifying highlighted communication event data of that communication event . The metadata is e.g. either applied manually to the conversation element or by using media processing in response to identifying predetermined media characteristics in the conversation element as explained in more detail below. This is in addition to any record metadata applied to highlighted and non-highlighted communication event records alike by the client 108 as part of normal record keeping by the record component 312.

The predetermined media characteristic may, for instance, be certain colours, shapes, movements etc. and/or certain combinations thereof occurring at a moment in a video (e.g. of a video call or video file transfer), and possibly at a particular spatial location in one or more frames of that video, or at a location in a still image (e.g. of an image file transfer). The media processing may, for instance, comprise the highlight component 302 selectively extracting highlighted media (e.g. audio or video) data from the media of the conversation element e.g. extracting one or more video frames occurring at that moment in the video, or extracting one or more video frame portions at that spatial location, or extracting a portion of the still image from that location in the image which can then be displayed on the display 204 to represent the corresponding communication event in an intuitive manner (i.e. the voice/video file transfer/image file transfer).

Highlighted communication event data is stored in memory 228 and can be marked as highlighted communication event data in a number of different ways, both during and after the communication event. Some types of communication event data—such as IMs or transferred files—may be stored in memory irrespective of whether that data is highlighted (that is, some types of communication event data may always be stored in memory); other types of communication event data (such as call audio, video or extracts thereof) may only be stored in memory if they are highlighted during the call—that is, the client 108 won't normally store real-time call audio or video (or at least will normally only store them temporarily e.g. in a buffer), but the highlight component 302 of the client 108 will nevertheless store in memory 228 any extracts of call audio or video that it marks as highlighted during the call and also an indication of a location in memory at which any such extract is stored, that indication being stored as part of the record of that communication event, so that the client 108 can retrieve such an extract for later use.

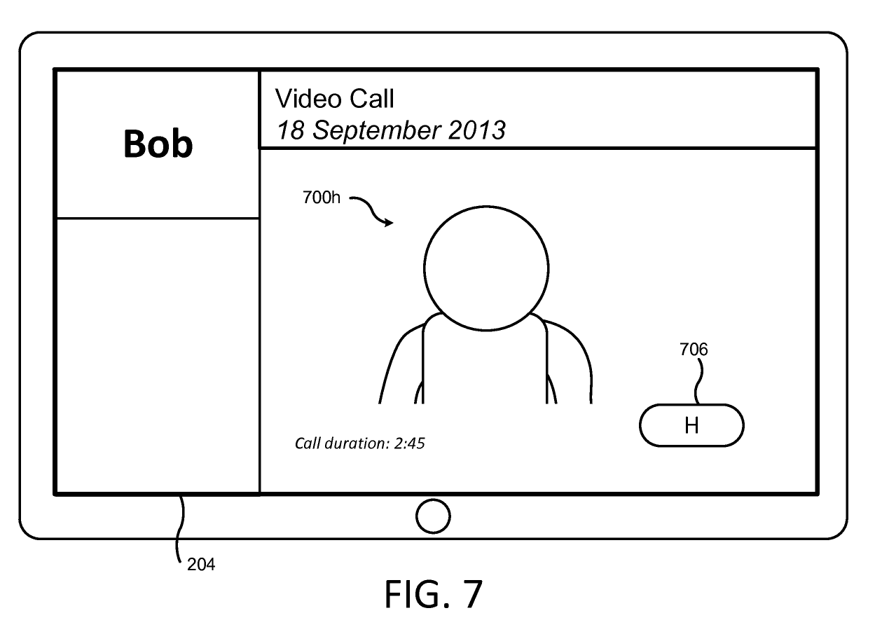

Various ways in which communication event data of a video call can be highlighted by the highlight component 302 will now be described with reference to FIG. 7. FIG. 7 shows an exemplary illustration of the user interface of Alice's client during a video call between Alice and Bob. A video stream 700h captured at Bob's user device 112 and transmitted to Alice's user device 104 over the network 106 in real-time is displayed on Alice's display 204. Communication data of the video call can be highlighted both manually and automatically.

For manual highlighting, a selectable highlight option 706 is displayed on Alice's display 706 which Alice 102 can select in order to highlight a moment of the video 700h currently being received.

For automatic highlighting, the highlight component 302 monitors the call video 700h throughout the call and is configured to recognize certain predetermined media characteristics in the call video occurring at a particular point or segment of the video. For instance, the highlight component 302 may analyze the call video 700h algorithmically during the call in order to recognize certain colours, shapes, movements etc. and/or certain combinations thereof occurring at a moment in the video 700h e.g. to recognize objects or actions of interest. Such video analysis algorithms are known in the art and can be applied to the call video 700h in a manner that will be apparent.

The highlight component responds to manual selection of the highlight option 706 and to automatic recognition of a predetermined media characteristic in the video 700h in the same way—in either event, the highlight component 302 takes a ‘snap-shot’ of the video 700h at that moment in time. That is, the highlight component 302 extracts a video frame currently displayed on the display 600 and stored the extracted video frame in memory 228. The extracted video frame constitutes highlighted communication event data of the video call, which the highlight component 302 marks as highlighted in the record of the video call stored in memory 228 by applying metadata thereto. The highlight component also stores in the record of the video call an indication as to where the extracted video frame is stored in memory 228 so that the client 108 can access it at a later time. Alternatively or additionally, rather extracting a single frame of video, the highlight component could capture a highlighted segment of the video (of length e.g. 1 second) and store it in an equivalent manner.

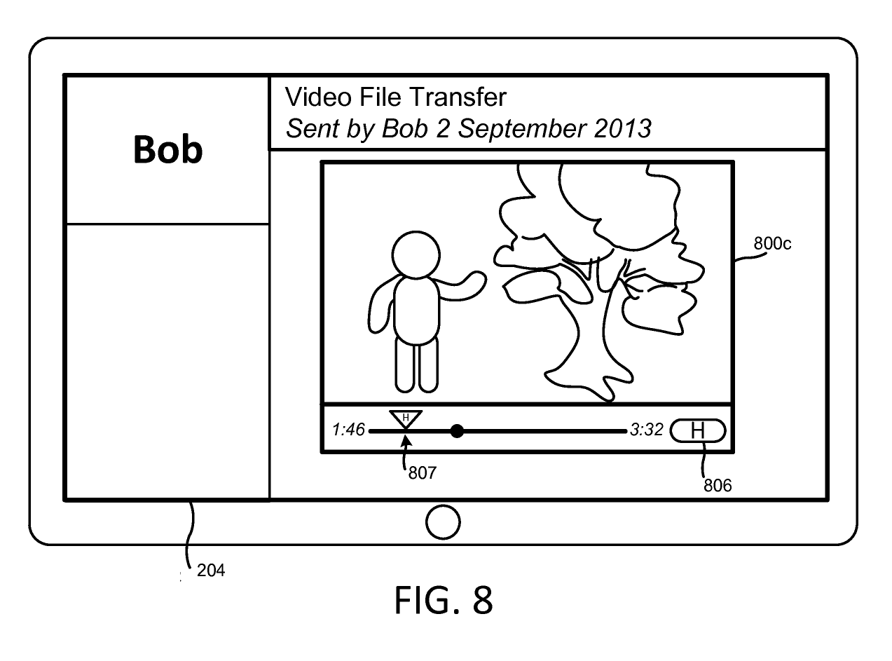

A manner in which communication event data of a video file transfer communication event can be highlighted by the highlight component will now be described with reference to FIG. 8. FIG. 8 shows an exemplary illustration of the user interface of Alice's client in a video-playback mode. In the video playback mode, the client 108 displays via the client user interface video 800c of a video file sent from Alice to Bob as part of a file transfer communication event. That is, in the video-playback mode, the client 108 plays out the received video file via the client user interface. The video file constitutes communication event data of the file transfer communication event, which can be selectively highlighted both manually and automatically as described below.

Also displayed is a selectable highlight option 806 for the purposes of manual highlighting. As the video 800c plays, Alice 102 can select the option 806 to indicate a favourite (temporal) point or segment in the video 800c. In embodiments, the user may be able to mark a particular spatial location at a moment in the video 800c as highlighted e.g. by selecting that location within the video.

For automatic highlighting, the highlight component 302 analyzes the received video file to recognize predetermined media characteristics in the received video occurring at a particular (temporal) point or segment, and optionally at a particular spatial location within with video. This is equivalent to the analysis that can be performed on call video which is described above, although as the video file is stored at the user device 104 the analysis can be performed after the communication event (i.e. after the file transfer has completed) in this instance and need not be performed during the communication event.

In response to either the user 102 manually selecting the option 806 or the analysis automatically revealing a predetermined media characteristic, the highlight component marks the corresponding point or segment of the video as highlighted e.g. by storing as part of the record of the video file transfer metadata comprising a temporal identifier identifying that point or segment as highlighted, or alternatively by extracting a frame or portion of the video 800c, storing it at a location in memory 228 (separate from the transferred video file itself) and augmenting the record of the video file transfer with an identifier of that location in a manner equivalent to marking real-time call video data as highlighted. The point or segment constitutes a reference point or segment in the video. In embodiments, the client also displays an indicator of that point or segment—for instance, the indicator 807 in FIG. 8 which is overlaid on a timeline of the video 800c.

Whilst the above is described with reference to video files which have been transferred from Bob to Alice, video files which have been transmitted from Alice to Bob as part of a file transfer communication event can also be highlighted at Alice's user device 104 in a similar manner by storing identifiers of highlighted communication event data in the record of that communication event at Alice's user device 104.

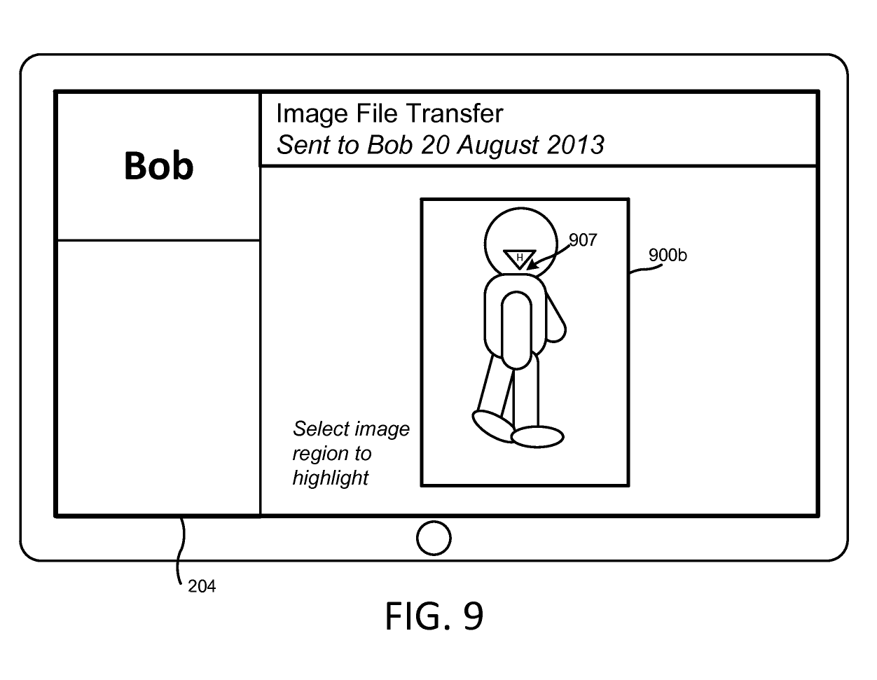

A manner in which communication event data of a static image file transfer communication event can be highlighted by the highlight component 302 will now be described with reference to FIG. 9. FIG. 9 shows an exemplary illustration of the user interface of Alice's client in an image-view mode. In this example, the client displays in the image-view mode an image 900b sent from Alice to Bob as part of a file transfer. The image constitutes communication event data transmitted to Bob as part of a file transfer communication event, which can again be selectively marked as highlighted either manually or automatically by the highlight component 302.

For manual highlighting, the user can select a particular (spatial) point or region of the image 900b e.g. by selecting that point or region via the touchscreen.

For automatic highlighting, the highlight component can analyze the image to recognize predetermined image characteristics. For instance the highlight component 302 may algorithmically analyze the image in order to recognize certain colours, shapes etc. and/or certain combination thereof occurring at a particular spatial location in the image.

In response to either the user 102 selecting a point or region of the image 900b or the analysis revealing a predetermined media characteristic, the highlight component marks the corresponding point or region of the image as highlighted e.g. by storing in the record of the image file transfer metadata comprising a spatial identifier identifying that point or region as highlighted, or by extracting a portion of the image at that location, storing it at a location in memory 228 (separate from the transferred image file itself) and augmenting the record of the image file transfer with an identifier of that location in memory 228. The point or segment constitutes a reference point or region of the image. In embodiments, the client also displays an indicator of that point or region—for instance, the indicator 907 in FIG. 9 which is overlaid on the image 900b at that point or region of the image 900b.

Whilst the above is described with reference to image files which have been transferred from Alice to Bob, image files which have been transmitted from Bob to Alice as part of a file transfer communication event can also be highlighted at Alice's user device 104 in a similar manner by storing identifiers of highlighted communication event data in the record of that communication event at Alice's user device 104.

A manner in which communication event data of past communication events can be manually highlighted by the highlight component 302 after those communication events have occurred will now be described with reference to FIG. 6. FIG. 6 shows an exemplary illustration of the user interface of Alice's client in the conversation mode. In the conversation mode, the client 108 accesses the records of past communication events stored in memory 228 and displays those records in sequence as conversation elements in a linear conversation history (see above). Respective selectable highlight options 606 are displayed in conjunction with the conversation elements. In response to the user 102 selecting one of the highlight options 606, the client marks the corresponding communication event data (e.g. an IM 600 or a transferred file 602) as highlighted by storing metadata identifying that communication event data as highlighted as part of the record of the corresponding communication event. As illustrated in FIG. 6, once highlighted, a different highlight option for a communication event may be displayed to show that it has been highlighted, and the user can un-mark the communication event as highlighted (that is, remove the highlighted communication event metadata from the record) by selecting the different highlight option.

Past communication event data can also be highlighted automatically by the highlight component 302 e.g. based on their respective records. For instance, the highlight component 302 can access the record of an IM communication session, which includes the past messages transmitted and received therein, and is be configured to mark e.g. certain IM messages (e.g. 600 in FIG. 6) as highlighted by recognizing certain predetermined textual characteristics—for instance, automatically highlighting IM messages which exceeds a certain length, or which contain particular punctuation (e.g. exclamation marks), and/or predetermined words of interest etc. The highlight component 302 may also, for instance, be configured to mark successfully completed media and/or other file transfers as highlighted. That is, file transfers may be marked as highlighted by virtue of them being successful completed.

At step S408 the grouping component 304 accesses the communication event records in memory 228 to group the communication events into a plurality of groups by matching parameters of the communication events stored in the records of the communication events. As discussed, the parameters of a communication event could be a timestamp of that communication event, a media type of that communication event, a location relating to that communication event (said location relating to the location of a communication client that participated in the communication event), and/or a topic of the communication event etc.

In this embodiment, the user 102 can select how they wish communication events to be grouped and displayed by the client 108. That is, the user 102 can elect to group the recorded communication events according to one of: highlights (viewed in a group-by-highlight mode), media type (viewed in a group-by-media type mode), place (viewed in a group-by-place mode) or topic (viewed in a group-by-topic mode).

The grouping component 304 groups communication event records (conversation elements) by highlight as follows. The grouping component 304 identifies conversation elements containing metadata indicating a highlighted moment, wherein the metadata is either applied manually to the conversation element or by using media processing in response to identifying predetermined media characteristics in the conversation element (see above). Each conversation element has a parameter in the form of an associated time stamp, and the grouping component sorts each conversation element containing said metadata into time groups representing a period of time (e.g. into calendar months). Upon selection of a search gesture by the user, a selectable UI element is provided representing each time group on the display to enable the user to search for (that is, navigate to) a particular conversation element containing said metadata by time group (see below).

That is, the grouping component first ‘filters’ the recorded communication events based on the highlighted moment metadata, and then groups the filtered communication events according to time into a plurality of time groups, such that each group corresponds to a particular time (or interval of time) and contains only highlighted communication events occurring at that time (or in that interval)—in this embodiment, non-highlighted communication events are excluded from the groups when grouping according to highlight.

In this embodiment, more recent communication events are grouped according to time with a finer granularity than less recent communication events. That is, at least one group of more recent communication events spans a shorter interval of time than at least another group of less recent communication events. Specifically, communication events from more recent months (e.g. events from the current month and/or from the month before the current month) are grouped according to day i.e. into a plurality of groups with each group being of communication events that occurred on the same day; communication events from less recent months are grouped according to month i.e. into a plurality of groups with each group being of communication events that occurred in the same month (but which might have occurred on different days in that month). Further granularity is envisaged, such as communication events from years other than the current year being grouped according to year (i.e. with year groups being of communication events that occurred in the same year) and/or most recent communication events being grouped according to time of day (e.g. with different groups representing different times of the same day).

Alternatively, non-highlighted communication events may not be excluded i.e. the grouping component 304 may be configured to simply group recorded communication events according to time based on their time stamps. Parameters other than, or in addition to, the time stamps could be used e.g. the communication events could be grouped according to location following the initial filtering.

That is, in embodiments, the grouping component 304 groups communication events according to time based on timestamps that form part of their respective records. In such embodiments, each record of a communication event includes a respective time stamp of that communication event indicating a time at which that communication event occurred, and the grouping component groups the communication events into a plurality of time groups by matching the respective time stamps of the communication events, each time group being of communication events that occurred within the same interval of time. The client user interface can then be operated by the client in a group-by-time mode (not shown) in which each group (of highlighted and possibly non-highlighted communication events) are represented using highlighted communication event data from that group, displayed as part of a respective UI element. Responsive to selection of that UI element, the access component access the record(s) of one or more communication events in that group, as in the other grouping modes described herein.

The grouping component 304 groups communication events by (media) type by identifying a communication event type relating to each communication event in at least one conversation of the conversation history—wherein said communication event type may be one of a video call type, and audio call type, an instant messaging type, or an image, video or other file transfer type—and sorts each communication event into communication event types. Upon detection of a search gesture by the user, a selectable UI element is provided representing each conversation type on the display to enable the user to search for (that is, navigate to) a communication event by communication event type (see below).

That is, communication events are grouped into a plurality of media type groups based on type parameters, with each group being of communication events of the same type.

The grouping component 304 groups communication events by place by determining a location relating to each communication event in at least one conversation, wherein said location relates to the location of a communication client participating in the communication event. Upon detection of a search gesture by the user a selectable UI element is provided representing each location on the display to enable the user to search for (that is, navigate to) a communication event by location (see below).

That is, the grouping component groups the communication events based on location parameters into a plurality of location groups, with each group being of communication events occurring at the same location (that is, in the same geographic area).

The grouping component 304 groups communication event records according to topic as follows. The communication events are grouped into a plurality of topic groups, each being of communication events relating to the same topic based on topic parameters (such as keywords extracted from message text or call audio, or an identifier of the topic determined based on such keywords). For instance, the grouping component 304 may parse words in the conversation history to identify topic, by identifying predetermined keywords relating to a particular topic, and sort conversation elements containing said keywords amongst each topic. Upon detection of a search gesture by the user, a selectable UI element is provided representing each topic on the display to enable the user to search for (that is, navigate to) a particular conversation element by topic (see below).

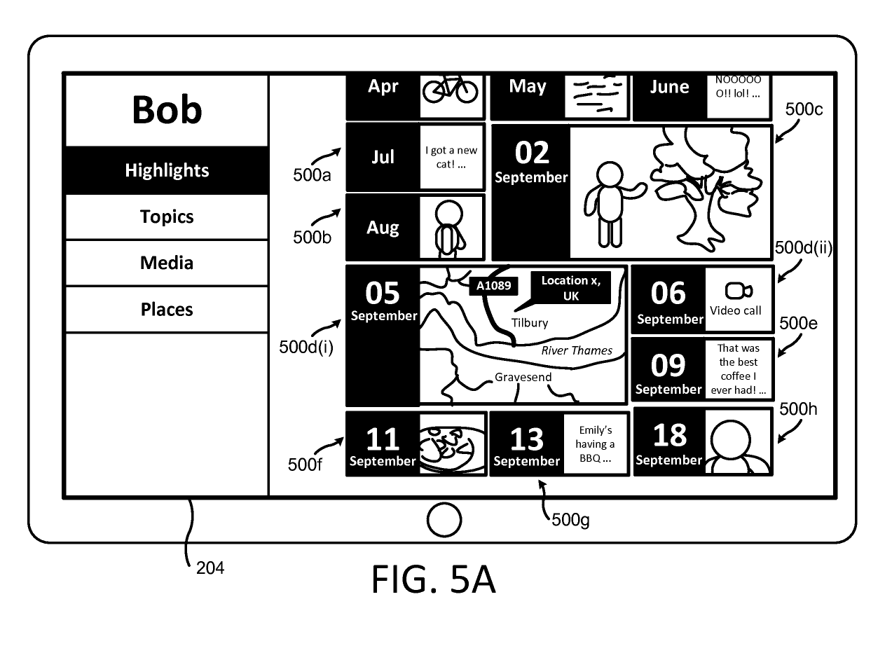

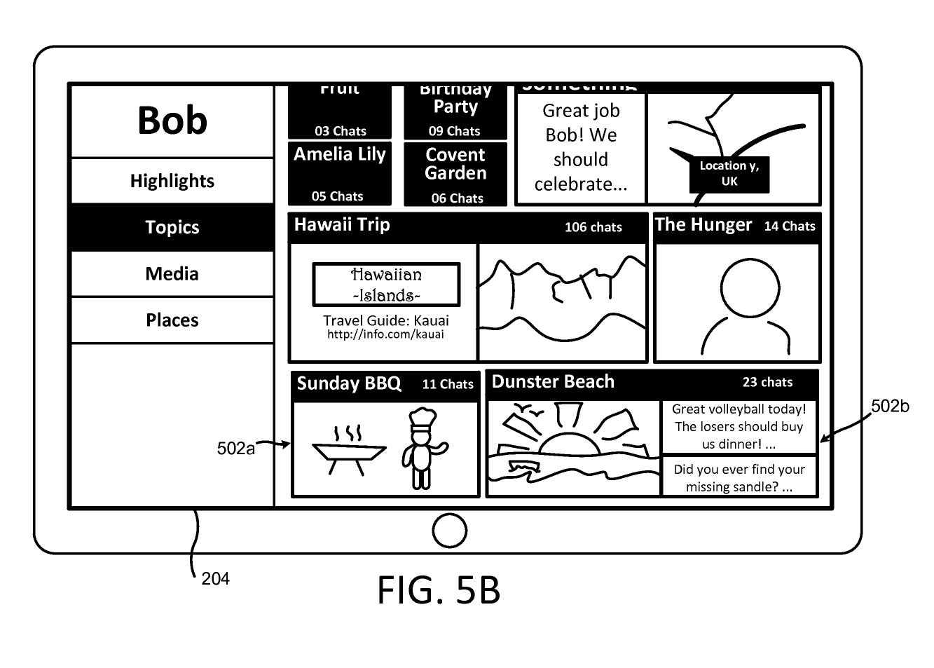

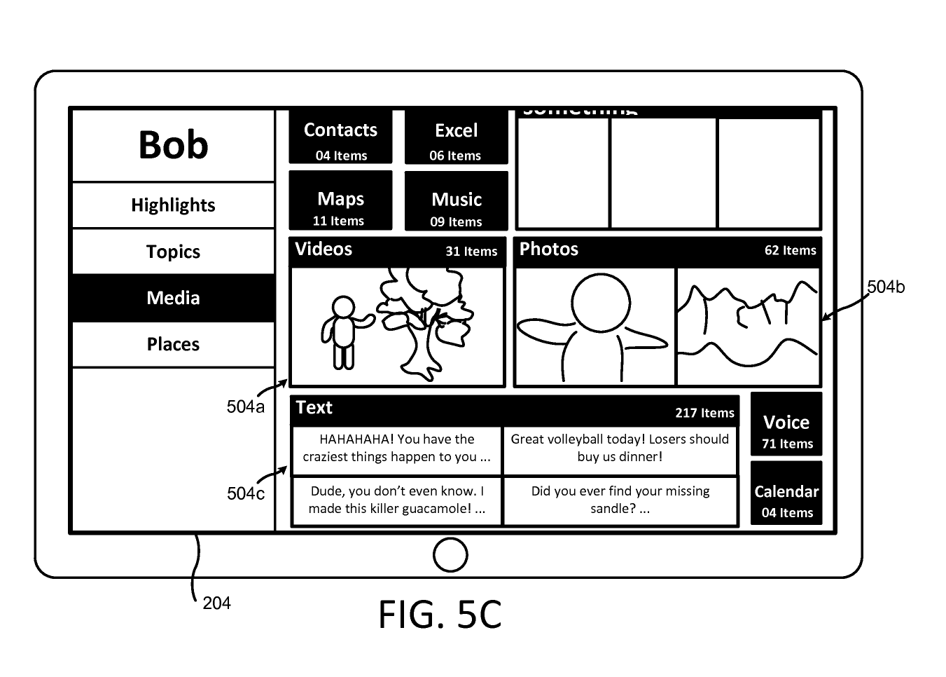

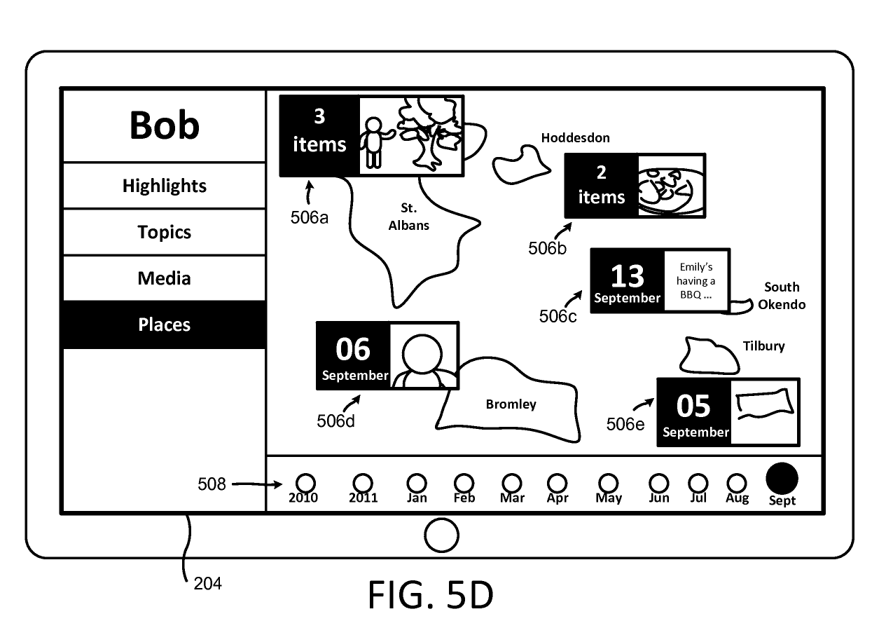

At step S410, the access component 306 of the client 108 represents a group of communication events by displaying a selectable user interface element (UI element) comprising highlighted communication event data of a communication event in that group. That is, the client uses highlighted communication event data (such as highlighted text, image or video data) to provide an intuitive and user-friendly overview of the contents (i.e. past communication events) of that group, which the user 102 can then select in order to efficiently navigate their conversation history in the manner described below. This is illustrated in FIGS. 5A to 5D which show the client user interface operating in a group-by-highlight mode, a group-by-topic mode, a group-by-media-type mode, and a group-by-place mode respectively. The user can enter one of these modes, or switch between modes, by making a suitable gesture detectable by a suitable input device of the user device—the input device being e.g. the touchscreen, the camera 208 or other sensor of the user device 104 (not shown) such as an infra-red depth sensor or similar—or by selecting an option to enter that mode presented via the client user interface.

In each of the modes, in response to the user 102 selecting one of these elements, the access component 306 accesses the respective record(s) of one or more communication events in that group e.g. to display additional information from that (those) records to the user and/or to display further UI elements each corresponding to a communication event of that group or sub-group of that group. For instance, in embodiments, upon selection of a UI element representing a group, the access component 306 displays respective further selectable UI elements for one, some or all of the communication events in that group, each selectable element comprising information about the corresponding communication event from the record of that communication event. Upon selection of the further UI element representing a particular communication event, the access component then switches the client user interface mode to the conversation mode (FIG. 6) and displaying the selected communication event in the context of the linear conversation history. That is, in response to the user 102 selecting the further UI element for a particular communication event, the access component 306 causes the display 204 to ‘jump’ to the point in the linear conversation at which that communication event occurred, thereby allowing the user 102 to navigate their (possibly extensive) conversation history in an efficient and intuitive manner, easily jumping to points in their conversation history that are most likely to be of interest to them (because they have been highlighted) via higher-level representations provided by the various grouping modes.

Each selectable UI element for a group is displayed in a respective portion of the available display area. In some or all of the client user interface grouping modes, this portion may have a size which is determined based on the number of communication events in that group e.g. with at least one group of more communication events occupying a larger portion of the available display area than at least another group of fewer communication events.

In embodiments, the grouping component 304 and the access component 306 can interact with one another (as represented by the double arrow therebetween in FIG. 3), such that the access component 306 can cause the grouping component 304 to change the way in which communication events are grouped. For instance, in one embodiment, upon selection of the UI element representing a particular group of communication events, the access component causes the grouping component to perform a further grouping operation in order to divide the communication events of that same group into a plurality of sub-groups, and the access component then displays respective UI elements for each of the sub-groups which the user 102 can select to access record(s) of communication events in those sub-groups.

In the group-by-highlight mode (FIG. 5A), the access component displays on the display 204 a plurality of selectable UI elements 500, each representing a different time group of communication events having highlighted communication event data grouped by the grouping component by highlight in the manner discussed above. As discussed, each time group may represent intervals of time of different lengths—in the example of FIG. 5A, the elements 500c-500h each represent respective group of communication events which occurred different respective days in September. The elements 500a and 500b represent groups of communication events occurring in different months—July and August respectively.

By selecting one of the elements 500, the user can access the record(s) of one or more communication events in the corresponding group e.g. to display some or all of the additional data from those record(s). For instance, upon selection of one of these elements 500c-500h, the access component 306 may access the records of one or more communication events to display further respective selectable elements for one, some or all of the communication events occurring on that day or in that month, selection of which takes the user to the corresponding point in the linear conversation history. Alternatively, selection of an element 500 may cause the grouping component 394 to access the records of the communication events in that group in order to divide those communication events into sub-groups—e.g. selection of elements 500a or 500b may cause the grouping component to divide the communication events in that group into sub-groups according to e.g. day-of-the-month; selection of elements 500c-500h may cause the grouping component to divide the communication events in that group into sub-groups according to e.g. time of day etc. to allow ‘fine-tuned’ navigation of past communication events. Respective selectable elements may then be displayed for the sub-groups, selection of which allows the user to access the records of those communication events.

Each of the displayed UI elements 500a-500c and 500e-h representing a respective group comprises displayed highlighted communication event data identified in the record of a communication event in that group. For instance, the UI element 500g represents the group of communication events which occurred on 13 Sep. 2013—this group includes an instant messaging session between Alice and Bob occurring on that day show which is displayed in FIG. 6. The IM sent from Bob to Alice at time 14:28 (600 in FIG. 6) is a highlighted IM from which text has been extracted and displayed as part of the UI element 500g. The UI element 500h represents the group of communication events which occurred on 18 Sep. 2013—this group includes the video call between Alice and Bob shown in FIG. 7, and is represented by highlighted communication event data, stored in the record of that call in the form of a snap-shot take by Alice of the call video 700h during that call. The UI element 500c represents the group of communication events which occurred on 2 Sep. 2013—this group includes the video file transfer shown in FIG. 8, and is represented by highlighted communication event data, stored in the record of that file transfer, in the form of the highlighted frame or portion of the video 800c (at time 807 in the video). The UI element 500b represents the group of communication events which occurred in August 2013—this group includes the image file transfer shown in FIG. 9, and is represented by highlighted communication event data, stored in the record of that file transfer, in the form of the highlighted portion of the transferred image 900b (at 907 in FIG. 9).

In embodiments, some groups may be represented by UI elements which do not comprise highlighted communication event data in addition to UI elements which do. For instance, the UI elements 500d(i), (ii) in FIG. 5A use a map portion (e.g. corresponding to a location of a communication event in that group) and an icon respectively (e.g. if no image or video is available) to represent groups of communication events from 5 September and 6 September respectively.

In the group-by-topic mode (FIG. 5B), a plurality of selectable elements 502 representing different topics are displayed. Each of the selectable elements 502a, 502b—representing topics of “Sunday BBQ” and “Dunster Beach” respectively—comprises displayed highlighted communication event data identified in the record of one or more communication events in the corresponding group. By selecting one of the elements 502, the user can access the record(s) of one or more communication events in the corresponding group e.g. to display some or all of the additional data from those record(s).

In this embodiment, each selectable element representing a corresponding group occupies a portion of the available display area having a size determined by the access component 306 based on the number of communication events in the corresponding group—e.g. the group represented by 502b is of more communication events (23 communication events) than the group represented by 502a (11 communication events). Based on this, the access component 306 controls the display (by generating suitable control signals) to display the UI element 502b representing the group of more communication events (“Dunster Beach”) in a larger portion of the available display than the UI element 502a representing the group of fewer communication events (“Sunday BBQ”).

In the group-by-media-type mode (FIG. 5C), a plurality of selectable UI elements 504 are displayed. The selectable UI elements 504 represent different media types—such as voice call, video call, instant message, image transfer, file transfer etc. Each element 504a (video file transfers, of which there are 31 recorded), 504b (image file transfers, of which there are 62 recorded), 504c (IM sessions, of which there are 217 recorded) comprises displayed highlighted communication event data of a communication event of that media type—e.g. the UI element 504a comprises one or more highlighted frames and/or video portions of one or more transferred video files (such as 800c in FIG. 8); the UI element 504b comprises one or more highlighted images or image portions of a one or more transferred image files (e.g. 900b in FIG. 9); the UI element 504c comprises one or more highlighted text portions extracted from one or more instant messages. By selecting one of the elements 504, the user can access the record(s) of one or more communication events in the corresponding group e.g. to display some or all of the additional data from those record(s).

In this embodiment, the access component 504 controls the display to display a UI element representing a group of more communication events (e.g. 504b, 504c) in a greater portion of the display than a UI element representing a group of fewer communication events (e.g. 504a, 504b).

In the group-by-place mode, a map cartographically representing a geographic region is displayed. Selectable UI elements 506 corresponding to respective location groups (or to individual communication events) are overlaid on the map at respective positions corresponding to the geographic areas of those groups (or individual communication events) as indicated by the location parameters in their respective records. The UI elements 506 comprise respective highlighted communication event data of one or more communication events in the corresponding group (or of the corresponding individual communication event). By selecting one of the UI elements 506 representing a group (or individual communication event), the user can accesses the record(s) of one or more communication events in that group (or the record of that individual communication event) e.g. to display some or all of the additional data from those records (that record).

The map has an adjustable scale, and the access component can zoom in at a particular location on the map by enlarging the map at that location, reducing the scale of the map, in response to a suitable user input e.g. the user making a pinch gesture on the touchscreen at that location. In response, communication events from a group of multiple communication events for a particular geographic region may be divided out by the grouping component, either into sub-groups and/or individual communication events, the sub-groups and/or individual communication events being for different respective sub-regions of the geographic region of the original group. Respective selectable UI elements are displayed by the access component for those sub-groups and/or those individual communication events at corresponding locations on the re-scaled map. Responsive to selection of one of these UI elements, the access component accesses the record of one or more communication events in the corresponding sub-group or, if the UI element represents to an individual communication event, the record of that individual communication event to display some or all of the additional data therefrom.

In the above, a user device comprises computer storage operable to store the respective records of the communication events; the highlight component operable to selectively mark transmitted and/or received communication event data of the communication events as highlighted communication event data; the grouping component configured to access the records to group the communication events into a plurality of groups by matching the respective parameters of the communication events; and the grouping component configured to generate control signals to control the display of the user device. That is, these components (computer storage, highlight component, grouping component, access component) constitute a computer system which, in the above, is embodied in the user device.

However, in alternative embodiments one or more of these components (computer storage, highlight component, grouping component, access component), or at least parts thereof, may not local to the user device and may instead be implemented remotely e.g. at a server and/or data centre of e.g. the network 106. In this case, the computer system may not be embodied in the user device (or may be only partially embodied in the user device), and may be embodied (at least partially) at one or more remote computer device(s) instead.

It should be noted that the term “record” is used herein to mean stored information about a past communication event, and does not imply that this information is stored conforming to any particular data structure or format.

Each record of a communication event may comprise additional information about that communication event, and the access component may be configured responsive to the user selecting the portion of the available display area in which a group is represented to access the record of at least one communication event in that group to display at least some of the additional information for the at least one communication event.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof (e.g. the functional blocks of FIG. 3). In the case of a software implementation, the module, functionality, or logic represents program code that performs specified tasks (e.g. the method steps of FIG. 4) when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user devices may also include an entity (e.g. software) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1. A computer system in which communication event data are transmitted and received between a user device and a communication network, the communication event data being of a plurality of communication events conducted over an interval of time, the computer system comprising:
computer storage operable to store respective records of the communication events, each record of a communication event including one or more parameters of that communication event;
a highlight component operable to selectively mark transmitted and/or received communication event data of the communication events as highlighted communication event data;
a grouping component configured to access the records to group the communication events into a plurality of groups by matching the respective parameters of the communication events; and
an access component configured to generate control signals to control a display of the user device to represent each of said groups by displaying, in a respective portion of an available display area of the display, the highlighted communication event data of a communication event in that group, wherein responsive to a user selecting that portion of the available display area the access component is configured to access the record of at least one communication event in that group.

2. A computer system according to claim 1 wherein the highlight component is operable to generate metadata identifying the highlighted communication event data and store the generated metadata in the computer storage.

3. A computer system according to claim 2 wherein the grouping component is operable to select a plurality of communication events having highlighted communication event data based on the stored metadata, and to group the selected communication events into the plurality of groups by matching the respective parameters of the selected communication events.

4. A computer system according to claim 1 wherein each record of a communication event includes a respective time stamp of that communication event indicating a time at which that communication event occurred; and
wherein the grouping component is configured to group the communication events into a plurality of time groups by matching the respective time stamps of the communication events, each time group being of communication events that occurred within the same interval of time.

5. A computer system according to claim 4 wherein each time group is a group of communication events that occurred on the same day, in the same month, or in the same year.

6. A computer system according to claim 1 wherein each record of a communication event includes a respective type parameter of that communication event indicating a type of that communication event; and
wherein the grouping component is configured to group the communication events into a plurality of type groups by matching the type parameters, each type group being of communication events of the same type.

7. A computer system according to claim 6 wherein the plurality of groups comprises:
a video call group of video call communication events, each type parameter of a communication event indicating whether or not that communication event is a video call communication event; and/or
an audio call group of audio call communication events, each type parameter of a communication event indicating whether or not that communication event is an audio call communication event; and/or
an instant messaging group of instant messaging communication events, each type parameter of a communication event indicating whether or not that communication event is an instant messaging communication event; and/or
an image group of image file transfer communication events, each type parameter of a communication event indicating whether or not that communication event is an image file transfer communication event; and/or
a video file transfer group of video file transfer communication events, each type parameter of a communication event indicating whether or not that communication event is a video file transfer communication event; and/or
a file transfer group of file transfer communication events other than image or video file transfer communication events, each type parameter of a communication event indicating whether or not that communication event is a file transfer communication event other than an image or video file transfer communication event.

8. A computer system according to claim 1 wherein each record of a communication event includes a respective location parameter of that communication event indicating a location of at least one participant during that communication event; and
wherein the grouping component is configured to group the communication events into a plurality of location groups by matching the location parameters, each location group being for a respective geographic area and of communication events during which at least one respective participant was within that geographic area.

9. A computer system according to claim 8 wherein the access component is further configured to control the display to display a map of a geographic region and to represent each group on the display at a position on the map corresponding to the geographic area of that group.

10. A computer system according to claim 1 wherein each record of a communication event includes a respective topic parameter indicating a topic to which that communication event relates, and the grouping component is configured to group the communication events into a plurality of topic groups, each topic group being of communication events relating to the same topic.

11. A computer system according to claim 10 wherein transmitted and/or received text of at least one communication event is stored in the computer storage, and the grouping component is configured to access the computer storage to assign to that communication event the respective topic parameter of the topic to which that communication event relates by identifying keywords relating to that topic in the stored text.

12. A computer system according to claim 1 where in the highlighted communication event data comprises:
transmitted and/or received text of one or more communication events, and/or
transmitted and/or received image data of one or more communication events, and/or
transmitted and/or received video data of one or more communication events; and
wherein the access component is configured to represent each group by displaying in the respective portion of the display area the highlighted text and/or image data and/or video data of a communication event in that group.

13. A computer system according to claim 1 wherein the highlight component is operable to mark at least a first portion of the transmitted and/or received communication event data as highlighted communication event data responsive to a user input at the user device.

14. A computer system according to claim 1 wherein the highlight component is operable to receive at least a second portion of the transmitted and/or received communication event data, automatically identify a predetermined characteristic of the received second portion, and mark the second portion as highlighted communication event data responsive to identifying the predetermined characteristic.

15. A computer system according to claim 14 wherein the second portion comprises media data; and
wherein the highlight component is operable to automatically identify a predetermined media characteristic of the media data and mark the media data as highlighted communication event data responsive to identifying the predetermined media characteristic, said marking of the media data by the highlight component comprising performing a media processing procedure on the media data.

16. A computer system according to claim 14 wherein the second portion comprises text communication event data and the highlight component is operable to process that communication event data by performing a text recognition procedure on that communication event data to identify the predetermined characteristic.

17. A computer system according to claim 1 wherein the transmitted and/or received communication event data comprises video data of a video call communication event and the highlight component is operable to mark part of the video data as highlighted communication event data during the video call communication event, said marking of the part of the video data by the highlight component comprising extracting that part from the video data and storing the extracted part in the computer storage.

18. A computer system according to claim 1 embodied in a user device.

19. At least one computer readable medium storing executable program code configured, when executed on a user device comprising a network interface and a display having an available display area, to implement a method of managing communication events conducted over a communication network, the method comprising:
transmitting and receiving communication event data between the user device and a communication network via the network interface, the communication event data being of a plurality of communication events conducted over an interval of time;
storing respective records of the communication events in computer storage, each record of a communication event including one or more parameters of that communication event;
selectively marking transmitted and/or received communication event data of the communication events as highlighted communication event data;
accessing the records to group the communication events into a plurality of groups by matching the respective parameters of the communication events; and
controlling the display to represent each of said groups by displaying in a respective portion of the available display the highlighted communication event data of a communication event in that group, wherein responsive to a user selecting that portion of the available display area the access component is configured to access the record of at least one communication event in that group.

20. A computer implemented method of managing communication events conducted over a communication network comprising:
transmitting and receiving communication event data between a user device and a communication network, the communication event data being of a plurality of communication events conducted over an interval of time;
storing respective records of the communication events in computer storage, each record of a communication event including one or more parameters of that communication event;
selectively marking transmitted and/or received communication event data of the communication events as highlighted communication event data;
generating metadata identifying the highlighted communication event data;
storing the generated metadata in the computer storage;
selecting a plurality of communication events having highlighted communication event data based on the stored metadata;
accessing the records to group the selected communication events into a plurality of groups by matching the respective parameters of the selected communication events; and
controlling a display to represent each of said groups by displaying in a respective portion of an available display area of the display the highlighted communication event data of a communication event in that group, wherein responsive to a user selecting that portion of the available display area the access component is configured to access the record of at least one communication event in that group.
